(19) United States
(12) Patent Application Publication
(10) Pub. No.: US 2015/0278880 A1
(43) Pub. Date: Oct. 1, 2015

(54) GENERATING SPONSORED CONTENT ITEMS

(71) Applicants: David A. Hotchkiss, Zurich (CH); Dimitris MERETAKIS, Zurich (CH)

(72) Inventors: David A. Hotchkiss, Zurich (CH); Dimitris Meretakis, Zurich (CH)

(21) Appl. No.: 14/437,160

(22) PCT Filed: Oct. 26, 2012
(86) PCT No.: PCT/GR2012/000048

§ 371 Date: Apr. 20, 2015

(51) Int. Cl. G06Q 30/02

(52) U.S. Cl. CPC G06Q 30/0276; G06Q 30/0277

(57) ABSTRACT

Methods, systems, and apparatus, including computer programs encoded on a computer storage medium, for generating sponsored content items. In one aspect, a method includes receiving a user request to generate a sponsored content item, the request including a media item representing an item for sale; extracting data from the media item, the extracted data being associated with one or more properties of the item represented by the media item; identifying product details in a product catalog using the extracted data; identifying similar items in a sponsored content item index using the extracted data, wherein the sponsored content item index includes a plurality of other sponsored content items describing items for sale; prompting the user for additional information using the similar items; and generating the sponsored content item using the media item, the extracted data, the additional information from the user, and user contact information.

### BACKGROUND

This specification relates to content presentation.

Sponsored content providers provide sponsored content items, e.g., advertisements, in different forms in order to attract consumers. An advertisement (“ad”) is a piece of information designed to be used in whole or part by a user, for example, a particular consumer. Sponsored content items can be provided in electronic form. For example, online ads can be provided as banner ads on a web page, as ads presented with search results, or as ads presented in a mobile application.

### SUMMARY

This specification describes technologies relating to generating sponsored content items.

A system can use image recognition to create a sponsored content item. The sponsored content item can be an ad by an individual for a single item or server, e.g., a classified ad. The system receives user selected media, e.g., an image, from a user device identifying an item for sale. For example, the user can provide an image corresponding to an item for sale. The system extracts information from the received media. Based on the extracted information, the system retrieves information regarding similar items to the item for sale, e.g., from other sponsored content items. The system can provide some or all of this information to the user. For example, the information can be provided directly or can be processed (e.g., aggregated, summarized, or filtered) prior to providing. The user device can display this information, e.g., a range of prices for items similar to the item for sale, and can prompt the user to enter additional information regarding the item for sale, e.g., a desired price. After the system receives additional information from the user device and incorporates details from a product catalog, the system can generate a sponsored content item for the item for sale.

In general, one innovative aspect of the subject matter described in this specification can be embodied in methods that include the actions of receiving a user request to generate a sponsored content item, the request including a media item representing an item for sale; extracting data from the media item, the extracted data being associated with one or more properties of the item represented by the media item; identifying product details in a product catalog using the extracted data; identifying similar items in a sponsored content item index using the extracted data, wherein the sponsored content item index includes a plurality of other sponsored content items describing items for sale; prompting the user for additional information using the similar items; and generating the sponsored content item using the media item, the extracted data, the additional information from the user, and user contact information. Other embodiments of this aspect include corresponding systems, apparatus, and computer programs, configured to perform the actions of the methods, encoded on computer storage devices.

These and other embodiments can each optionally include one or more of the following features. The extracted data includes a title or description. The media item is an image, audio, video, or rich text. Sending the product details to the device, the product details including attributes and specification of the media item, which can cause the device to auto-populate fields associated with the sponsored content item. Sending a range of prices for the similar items to the device. The additional information includes a title, description, price or specification of the item for sale. Retrieving the user contact information. The user contact information includes a user ID, user name, email, phone number, or other identifying contact information. The user contact information is retrieved from a user database or from the user.

Particular embodiments of the subject matter described in this specification can be implemented so as to realize one or more of the following advantages. The system can quickly generate a sponsored content item after a seller submits an image. The user does not have to provide as much information because the system extracts information from the image and can automatically fill in information about the sponsored content item. Based on the item represented in the image, the system can find similar items through a sponsored content item index. A price range of similar items can be displayed to the user, guiding the user to make an informed decision regarding what information to put in the sponsored content item. The system can auto-populate key characteristics for a sponsored content item. The characteristics can be retrieved from a product catalog. For example, if the item is a car, the characteristics include a model, make, price, and additional car features. Another advantage is that the system can automatically incorporate user contact information when generating a sponsored content item.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a schematic diagram of an example system that uses image recognition to create sponsored content items.

FIG. 2 is a flow chart of example communications between a client and an ad system.

FIG. 3 is a flow chart of an example method of an ad system.

FIG. 4 is a flow chart of an example method of providing an advertisement for presentation.

FIG. 5 is a diagram of an example view of a sponsored content item on a user device.

Like reference numbers and designations in the various drawings indicate like elements.

### DETAILED DESCRIPTION

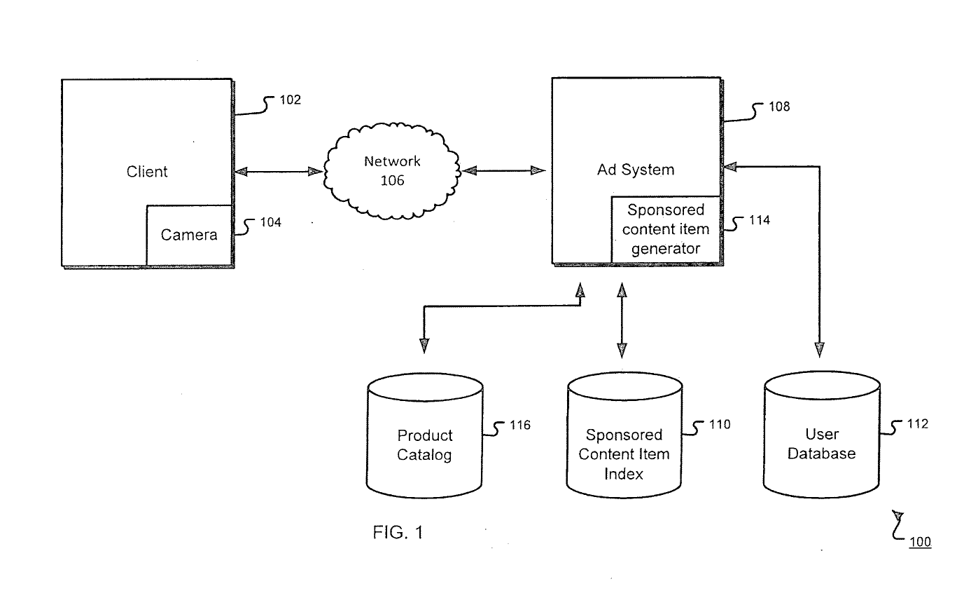

FIG. 1 is a schematic diagram of an example system 100 that uses image recognition to create sponsored content item, e.g., classified advertisements. Classified advertisements are examples of a particular type of sponsored content item, e.g., a single conversion sponsored content item. A conventional classified ad is an advertisement by a particular individual for a single item or service. Generally speaking, clients and an ad system 108 can be data processing apparatus, for example, handheld devices, rack-mounted servers, or other computing devices. The data processing apparatus within the ad system 108 can be in the same physical location (e.g., data center) or can be in different physical locations. The clients and ad system 108 can have different capabilities and computer architectures. In some implementations, a client 102 is an end-user device e.g., a personal computer, a laptop computer, a tablet computer, or a cellular phone. The client 102 communicates with the ad system 108 over a network 106. The client includes a camera 104 for generating images. The ad system 108 can have a sponsored content item generator 114 that generates ads based on information from the client 102, a sponsored content item index 110, a user database 112, and a product catalog 116.

In some implementations, the ad system 108 accesses the sponsored content item index 110. The index 110 can be an electronic file system, a distributed file system, or other network-accessible persistent storage that can store information on computer-readable storage media. The index 110 can include one or more data processing apparatus and one or more computer-readable media. In some implementations, the sponsored content item index 110 contains advertisements of numerous items for sale from different clients. In some implementations, the sponsored content item index 110 contains, for each sponsored content item, one or more of a title, description, price, item information, one or more images, or owner information. For example, if the item in the sponsored content item index is a car, the item information can include one or more of a make, model, year, mileage, or additional vehicle options.

In some implementations, the ad system 108 accesses a user database 112. The user database 112 can be an electronic file system, a distributed file system, or other network-accessible persistent storage that can store information on computer-readable storage media with one or more data processing apparatus. In some implementations, the user database 112 contains information on users accessing the system, e.g., user profile information. For example, the information can include the user's name, phone number, email, or preferred contact type. The information can be used to automatically provide information in the sponsored content item created by the system for the user, for example, adding contact information to the sponsored content item based on user preferences so that a potential buyer can contact the user. The user can be provided with an opt-in option to have their user preferences or contact information provided when generating the sponsored content item.

In some implementations, the ad system 108 accesses a product catalog 116. The product catalog 116 can be an electronic file system, a distributed file system, or other network-accessible persistent storage that can store information on computer-readable storage media with one or more data processing apparatus. In some implementations, the product catalog 116 contains details on multiple items. For example, the details can include an item's title, description, or additional options. The details can also include brand or model. The ad system 108 can use this information from the product catalog 116 to automatically incorporate item details into the sponsored content item prior to generation.

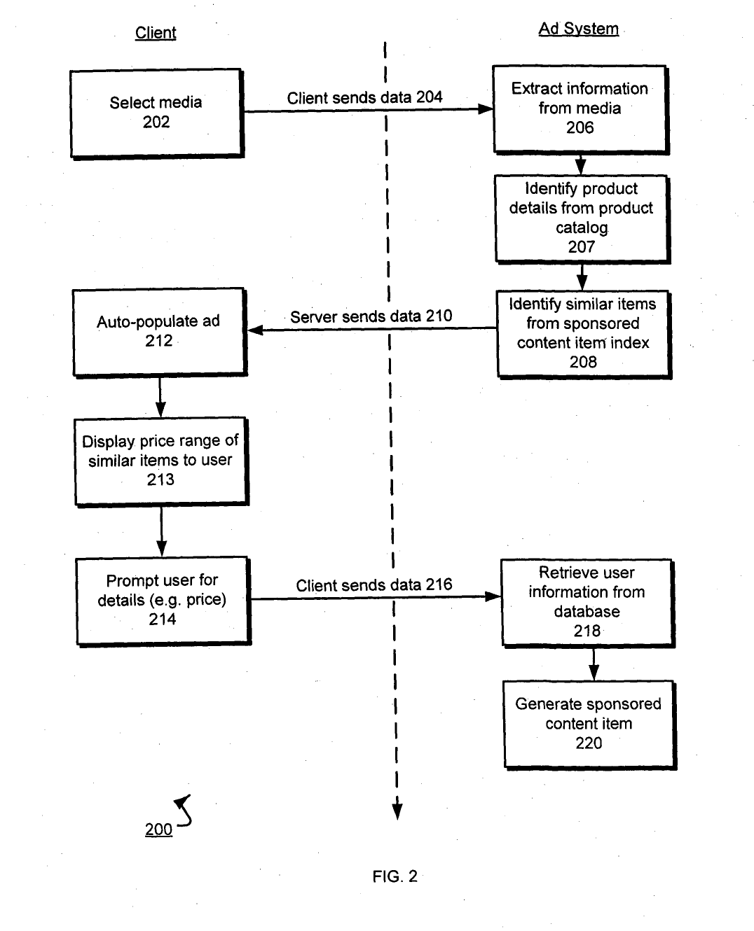

FIG. 2 is a flow chart of example communications 200 between a client and an ad system. The client selects media 202 identifying an item for sale. In some implementations, this media includes an image, audio, video, or text that describes the item for sale. The client can capture the media using a camera, for example a camera incorporated into a mobile client device. Alternatively, the user can select from media stored on a device, for example, stored image files or image files downloaded from another device, e.g., a separate camera. The client sends data including the media to the ad system 204. In some implementations, this data also includes a location, user identifying data, time, or other information related to the client.

After receiving the data, the ad system extracts information from the media 206. For example, if the media received is an image of a car, the ad system can extract the color, vehicle type, make, or model of car from the image. In some alternative implementations, the image is provided to an extraction system that returns information extracted from the image.

The system then can identify product details from a product catalog 207 based on the extracted information. For example, if the system extracted a model of the car, the product catalog can provide information about specifications of the car, such as the car's features, e.g., whether it has four wheel drive. If the system determines with confidence that the image matches an entry in the product catalog, the system can include information about the product in the system's communication with the client.

The extracted information also enables the ad system to identify similar items to the item for sale 208. The system can search similar items in the sponsored content item index by comparing titles or descriptions. Entries in the sponsored content item index can be linked to products in the product catalog. Therefore, the system can also search similar items in the sponsored content item index by searching a product's make or model.

After obtaining similar items to the item for sale from the sponsored content item index, the ad system can then send data derived from the similar items to the client 210. In some implementations, the data includes a range of prices that are associated with the identified similar items. For example, if the item for sale is a sedan and the ad system identified similar sedans having prices ranging from $3,000 to $4,000, the data can be provided to the client. In another example, if the item for sale is a computer, the ad system can identify a price range of computers having similar specifications, e.g., $1,200-$1,500. The ad system can provide the price range to the client. Providing this pricing information for similar items to the client can educate a user to make an informed decision as to what price should be set for the item on sale.

In some implementations, the data includes the product details from the product catalog described above. For example, this data can include color, model, or additional features of the media received by the ad system. Upon receiving the product details, the client can auto-populate an ad 212 with product details, which facilitates creation of the ad. This data can also serve to confirm with the user that information about the image is properly identified. In some implementations, the client prompts the user with a message to confirm the correct identification of the image. For example, “Identified a 2000 Brand X Model Y, is this correct?”

After receiving data from the ad system, the client displays a price range of the similar items 213. For example, the client can display “Your item recently listed for $3,000-3,300 USD.” In some implementations, the client then prompts the user to enter in details 214, for example, a price for the item on sale. For example, the client can display a dialog box asking the user to enter input for additional information. The client can prompt the user for additional information other than price. For example, if the item on sale is a car, additional information can include mileage. Or if the item on sale is an electronic device, additional information can include when the user purchased the electronic device. In some implementations, the client prompts for user identifying information such as a name or contact information. After the user provides the additional information, the client sends the data, including the prompted information, to the ad system 216.

The ad system receives the data from the client. In some implementations, the received data includes the price of the item. In some other implementations, the received data supplies additional details regarding the advertisement, for example, a timestamp or location of the device. In some implementations, the client's response includes user information. For example, user information can include a user's name, login information, or contact information. In some implementations, the ad system retrieves user information from a user database 218.

In some alternative implementations, the ad system retrieves the user information when the user submits an image. In further alternative implementations, the system can draw partially from the user database and partially from user submitted contact information that was received from the client. The user can also specify what type of contact information to include in the ad, for example, only a phone number, only an email, or only phone number and email. The ad system can associate the user information with the item for sale.

The ad system generates the sponsored content item 220. For example, the sponsored content item can include the original image, title, description, price, the seller's name, or the seller's contact information. In some implementations, the advertisement only requires an image before it is generated. The ad system can then store the sponsored content item in the sponsored content item index or another database.

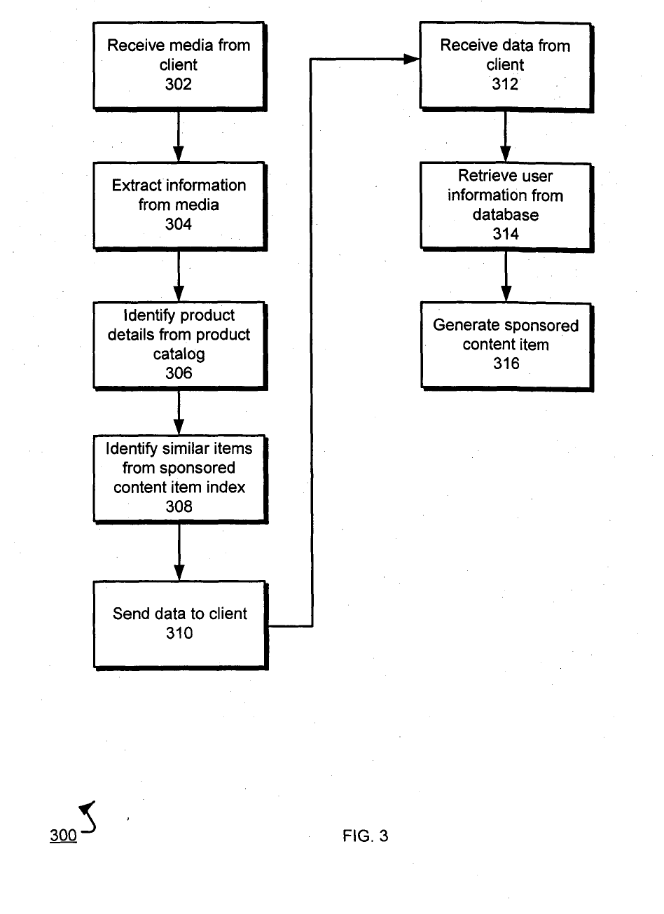

FIG. 3 is a flow chart of an example method 300 of generating a sponsored content item through an ad system. For convenience, the method 300 will be described with respect to a system having one or more computing devices that performs the method 300. The system receives media from a client 302. The system then extracts information from the media 304. With the extracted information, the system identifies product details of the media from a product catalog 306. The system can also identify similar products from a sponsored content item index 308. The system then sends data, which can pertain to product details or similar products, to the client 310. The system then receives the data, which can include user preferences or additional information, from the client 312. Next, the system can retrieve user information 314 from a database. The system generates a sponsored content item 316. The system can store the generated sponsored content item in the sponsored content item index or another database.

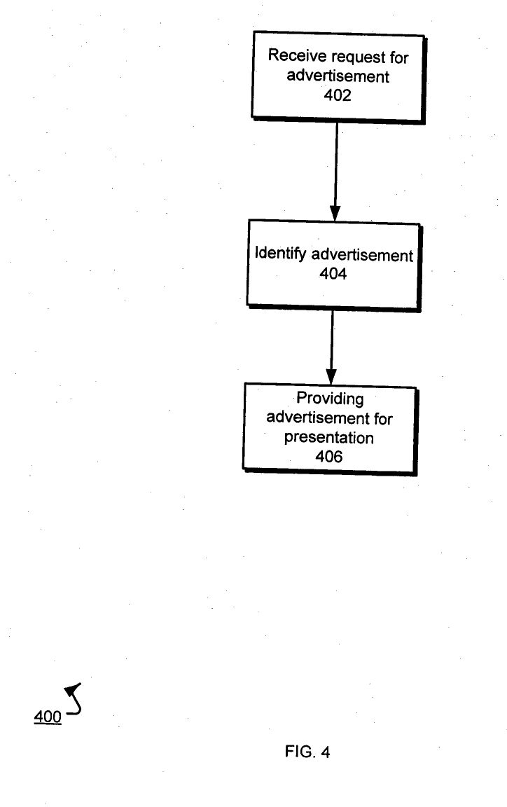

FIG. 4 is a flow chart of an example method 400 of providing an advertisement for presentation. For convenience, the method 400 will be described with respect to a system having one or more computing devices that performs the method 400.

The system receives a request for an advertisement 402. The request can be a request to provide an advertisement within a rendered web page or search results. Alternatively, the request can be part of a request to provide a group of sponsored content items to browse, e.g., a request to provide a group of sponsored content items corresponding to bicycles for sale. In some implementations, the system receives a request from a mobile device. In some other implementations, the system receives a request from another type of computing device, e.g., a desktop, tablet, or laptop computer.

The system identifies an advertisement 404 responsive to the request. In particular, the system can identify a sponsored content item from a sponsored content item index or another database as responsive to the request. The system provides the identified ad for presentation 406. For example, the ad can be provided to a client device to be rendered by a browser along with other content.

For example, a user can enter a search query into a search engine. The search engine, in addition to compiling a resulting list of search results, can route the query to an ad system.

Ads relevant to the query are identified. For example, ads with keywords that are the same, similar to, or synonymous with words in the search query can be identified. The identified ads can include a collection of candidate ads that match the keywords or other criteria. The ad system can then select particular ads from the collection of candidate ads. In some implementations, the ads are ranked according to one or more scoring criteria (e.g., based on the degree of match between the query and the ad keywords). One or more top scoring ads can be selected. In particular, the selected ads include a sponsored content item for a particular item or service from a user. The sponsored content item can be a single conversion ad, meaning that the item identified in the ad can only be purchased once, resulting in a single ad conversion.

In some implementations, the location of the user and location targeting information associated with an ad can be used in identifying or ranking ads. For example, a sponsored content item having location targeting information indicating personal delivery in a twenty mile radius (e.g., ads for a couch or firewood) from the seller can have presentation limited to those potential buyers within the twenty mile radius (e.g., they can be omitted from candidate ads or can have a large location based penalty to the score when ranking candidate ads). In another example, a sponsored content item with location targeting information indicating a ship-from address (e.g., ads for a book, collectable, or handbag) can be ranked in part based on estimated shipping costs from the seller to the user.

One or more selected ads are presented to the user along with the search results. In some implementations, the ads can be formatted or differentiated from the search results to indicate which of the presented elements are ads and which are search results. The presented ads include the selected sponsored content item.

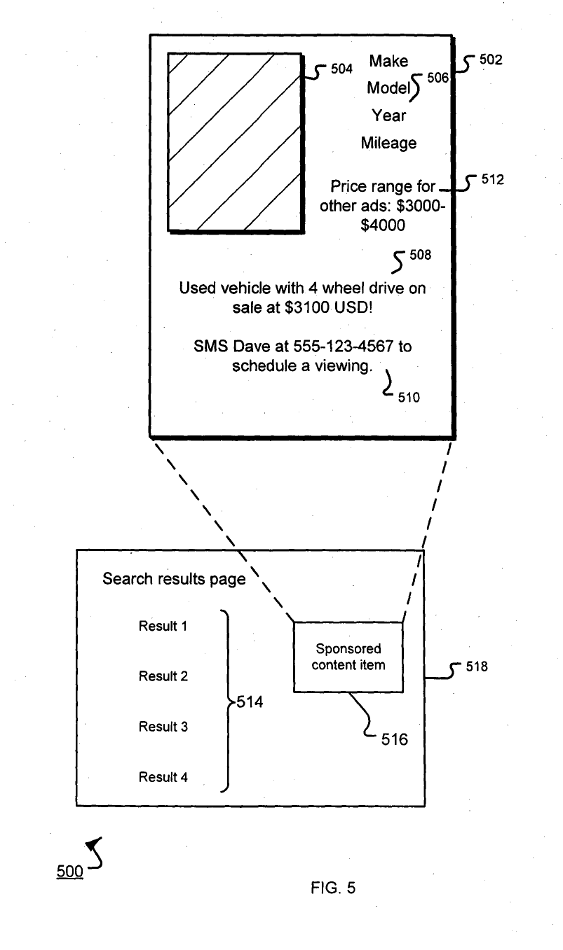

FIG. 5 is a diagram of an example view 500 of a sponsored content item embedded within search results. The advertisement can be provided for display on a user device 502. For example, in response to an ad request, the ad system can identify the ad to be provided. In the example ad 516 shown in FIG. 5, the advertisement is for a vehicle. The ad 516 includes an image 504 of the item for sale, a make, model, year, and mileage 506 of the vehicle. The ad also includes a description 508 of the item for sale, user information 510, and a price range 512. The user information 510 can allow the user of the user device 502 to contact the seller of the item for sale. For example, if a phone number is displayed, the client can provide a link that can place a call to the phone number. If an email address is displayed, the client can create a new email message with the recipient being the seller's email in response to a user selection of the email address. In some implementations, links for contact information (for example, phone number and email address) are embedded within the content of the data received from the ad system.

The ad can be embedded within a results page 518. Results page 518 shows search results 514 generated in response to a search query ‘Sedan’ submitted by a user associated with a particular location (e.g., location can be identified for the user based on a laptop with GPS, cell phone with tower triangulation, etc) in San Francisco. The single conversion ad 516 was created with the keyword ‘Sedan’ by a seller with a home address in the San Francisco area. The ad 516 was selected as relevant to the search query by an ad manager because both a keyword and city associated with the ad matched a keyword and city associated with the search query. This is an example of an ad being provided with search results. The ad 516 can be provided with other content, for example, on a particular web page.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language resource), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending resources to and receiving resources from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method performed by data processing apparatus, the method comprising:
receiving a user request to generate a sponsored content item, the request including a media item representing an item for sale;
extracting data from the media item, the extracted data being associated with one or more properties of the item represented by the media item;
identifying product details in a product catalog using the extracted data;
identifying similar items in a sponsored content item index using the extracted data, wherein the sponsored content item index includes a plurality of other sponsored content items describing items for sale;
prompting the user for additional information using the similar items; and
generating the sponsored content item using the media item, the extracted data, the additional information from the user, and user contact information.

2. The method of claim 1, wherein the extracted data includes a title or description.

3. The method of claim 1, wherein the media item is an image, audio, video, or rich text.

4. The method of claim 1, further comprising:
sending the product details to a user device, the product details including attributes and specification of the media item, which can cause the device to auto-populate fields associated with the sponsored content item.

5. The method of claim 1, further comprising:
sending a range of prices for the similar items to a user device.

6. The method of claim 1, wherein the additional information includes one or more of a title, description, price, or specification of the item for sale.

7. The method of claim 1, further comprising:
retrieving the user contact information.

8. The method of claim 1, wherein the user contact information includes one or more of a user identifier, user name, email, phone number, or other identifying contact information.

9. The method of claim 1, wherein the user contact information is retrieved from a user database or from the user.

10. A system comprising:
a processor; and
computer-readable medium coupled to the processor and having instructions stored thereon, which, when executed by the processor, cause the processor to perform operations comprising:
receiving a user request to generate a sponsored content item, the request including a media item representing an item for sale;
extracting data from the media item, the extracted data being associated with one or more properties of the item represented by the media item;
identifying product details in a product catalog using the extracted data;
identifying similar items in a sponsored content item index using the extracted data, wherein the sponsored content item index includes a plurality of other sponsored content items describing items for sale;
prompting the user for additional information using the similar items; and
generating the sponsored content item using the media item, the extracted data, the additional information from the user, and user contact information.

11. The system of claim 10, wherein the extracted data includes a title or description.

12. The system of claim 10, wherein the media item is an image, audio, video, or rich text.

13. The system of claim 10, further comprising:
sending the product details to a user device, the product details including attributes and specification of the media item, which can cause the device to auto-populate fields associated with the sponsored content item.

14. The system of claim 10, further comprising:
sending a range of prices for the similar items to a user device.

15. The system of claim 10, wherein the additional information includes one or more of a title, description, price, or specification of the item for sale.

16. The system of claim 10, further comprising:
retrieving the user contact information.

17. The system of claim 10, wherein the user contact information includes one or more of a user identifier, user name, email, phone number, or other identifying contact information.

18. The system of claim 10, wherein the user contact information is retrieved from a user database or from the user.

19. A computer-readable medium having instructions stored thereon, which, when executed by a processor, cause the processor to perform operations comprising:
receiving a user request to generate a sponsored content item, the request including a media item representing an item for sale;
extracting data from the media item, the extracted data being associated with one or more properties of the item represented by the media item;
identifying product details in a product catalog using the extracted data;
identifying similar items in a sponsored content item index using the extracted data, wherein the sponsored content item index includes a plurality of other sponsored content items describing items for sale;
prompting the user for additional information using the similar items; and
generating the sponsored content item using the media item, the extracted data, the additional information from the user, and user contact information.

20. The computer-readable medium of claim 19, wherein the extracted data includes a title or description.

21. The computer-readable medium of claim 19, wherein the media item is an image, audio, video, or rich text.

22. The computer-readable medium of claim 19, further comprising:
sending the product details to a user device, the product details including attributes and specification of the media item, which can cause the device to auto-populate fields associated with the sponsored content item.

23. The computer-readable medium of claim 19, further comprising:
sending a range of prices for the similar items to a user device.

24. The computer-readable medium of claim 19, wherein the additional information includes one or more of a title, description, price, or specification of the item for sale.

25. The computer-readable medium of claim 19, further comprising:
retrieving the user contact information.

26. The computer-readable medium of claim 19, wherein the user contact information includes one or more of a user identifier, user name, email, phone number, or other identifying contact information.

27. The computer-readable medium of claim 19, wherein the user contact information is retrieved from a user database or from the user.
